(19) United States
(12) Patent Application Publication
(10) Pub. No.: US 2024/0222041 A1
(43) Pub. Date: Jul. 4, 2024

(54) COMPLIANT MECHANISM FOR ENERGY HARVESTING GENERATOR ACTUATION

(71) Applicant: WePower Technologies LLC, Sagaponack, NY (US)

(72) Inventor: Michael Joseph Riddell, Glastonbury, CT (US)

(21) Appl. No.: 18/403,619

(22) Filed: Jan. 3, 2024

Related U.S. Application Data
(60) Provisional application No. 63/437,116, filed on Jan. 4, 2023.

(51) Int. Cl. H01H 9/02

(52) U.S. Cl. CPC H01H 9/02

(57) ABSTRACT

Disclosed is a compliant mechanism that may be used in connection with energy harvesting technologies. In some embodiments, the compliant mechanism may be an actuation mechanism that is three-dimensionally printed and includes one or more stable states. In some embodiments, the actuation mechanism may be compressed prior to being inserted into a housing. The compliant mechanism may include a compressible frame that is compressible between a neutral configuration and a compressed configuration. The compressible frame may include a first sidewall with ends having corner members, a second sidewall with ends having corner members, the second sidewall spaced apart from the first sidewall, and the second sidewall connected to the first sidewall by at least one flexure, and at least one actuation component positioned along the at least one flexure.

### CROSS REFERENCE TO RELATED APPLICATIONS

The application claims priority under 35 U.S.C. § 119(a) to U.S. Provisional Application No. 63/437,116, filed on Jan. 4, 2023 and entitled “COMPLIANT MECHANISM FOR ENERGY HARVESTING GENERATOR ACTUATION,” the disclosure of which is incorporated by reference herein in its entirety.

### TECHNICAL FIELD

The present disclosure is generally directed towards compliant mechanisms, and more particularly, compliant mechanisms that may be used for actuation of energy harvesting generators.

### BACKGROUND

Compliant mechanisms may include mechanisms that, at least in part, gain mobility from the deflection of the flexible members within the mechanisms rather than from movable joints only. In some embodiments, compliant mechanisms may be advantageous over conventional systems due to the reduction in the number of required parts in the resulting device and their ability to be manufactured using techniques such as 3D printing, plastic extrusion processes, injection molding, and the like. Further, because compliant mechanisms may require less components or parts, and may be manufactured using a variety of efficient techniques, compliant mechanisms may provide immense cost and time savings to a manufacturer and an end-user. Compliant mechanisms may also be used in systems requiring precise performance because compliant mechanisms may provide improved precision, accuracy, and repeatability than conventional systems due at least in part to compliant mechanisms experiencing less friction and backlash.

Some conventional compliant mechanisms generated by three-dimensional (3D) printing, molding, or other means, are limited in that the resulting compliant mechanisms are often prone to asymmetric actuation. This may be due to the fact that some conventional compliant mechanisms are manufactured such that they are relatively free of any stresses in the “as molded” or “as printed” and this as molded or as printed state represents a stable equilibrium position used by the end application. For example, while components of switches may be printed in an initial stable position, when the switch is moved to a second stable position, additional strains and stresses are applied to members of the compliant mechanism portion of the switch. The additional strain and stresses placed on the members of the compliant mechanism result in bowing of the flexures in the compliant mechanism. The added stress or strain from moving from one stable state (as printed) to a second stable state (as actuated) may result in the buckling of components of the compliant mechanism. Accordingly, in conventional compliant mechanisms, a first stable state may have no stress or strain, while a second stable state may result in a lot of stress and strain, and may thereby cause asymmetric actuation. Subsequently a user may feel asymmetric force in transitioning the device from one stable state to another.

Asymmetric actuation limits the ability of conventional compliant mechanisms from being used in energy harvesting generation activities, which may require symmetry in operation. Further, asymmetric actuation may result in needing different forces when moving from one stable state to another stable state, thereby providing a different “feel” to a user when they actuate between the two stable states.

Accordingly, there remains a need for compliant mechanisms that may provide symmetrical snap action, force, and feel, while having two or more stable states.

### SUMMARY

Various embodiments of compliant mechanisms are provided.

Embodiments of the present disclosure are directed towards compliant mechanisms that may provide symmetrical snap action, force, and feel.

Embodiments of the present disclosure may include an actuation mechanism having a compressible frame that is compressible between a neutral configuration and a compressed configuration, the compressible frame further including a first sidewall with ends having corner members, a second sidewall with ends having corner members, where the second sidewall is spaced apart from the first sidewall, and the second sidewall is connected to the first sidewall by at least one flexure, and at least one actuation component positioned along the at least one flexure, wherein the corner members of the first sidewall are spaced apart from the corner members of the second sidewall in the neutral configuration of the compressible frame, where the corner members of the first sidewall are adjacent to the corner members of the second sidewall in the compressed configuration of the compressible frame, where the at least one flexure buckles in the compressed configuration of the compressible frame, and where at least one of the two sidewalls, corner members, and at least one flexure includes compliant materials. Optionally, the actuation component may be a switch.

Optionally, the compressible frame may include a first stable state within the compressed configuration in which the at least one actuation component is in a first position. Optionally, the compressible frame may include a second stable state within the compressed configuration in which the at least one actuation component is in a second position. Optionally, actuation from the first stable state to the second stable state may use equivalent force as actuation from the second stable state to the first stable state. In some embodiments, movement of the at least one actuation component actuates the mechanism from the first stable state to the second stable state or from the second stable state to the first stable state. Optionally, the actuation component may be a switch.

In some embodiments a method may include the steps of manufacturing a compressible frame, the compressible frame further including a first sidewall with ends having corner members, a second sidewall with ends having corner members, the second sidewall spaced apart from the first sidewall, and the second sidewall connected to the first sidewall by at least one flexure, and at least one actuation component positioned along the at least one flexure, where at least one of the two sidewalls, corner members, and at least one flexure comprises compliant materials. The method may also include the steps of compressing the compressible frame by applying force to the first sidewall and the second sidewall of the compressible frame, inserting the compressed frame into a housing for electromagnetic applications, and actuating the actuation component from a first stable state position to a second stable state position. Optionally, manufacturing the compressible frame may include at least one of three-dimensional (3D) printing, plastic extrusion processes, and injection molding. Optionally, the actuation component may be a switch. Optionally, the ends of the at least one flexure may include rounded edges configured to engage with a receiving element on at least one of the two sidewalls, and corner members. Optionally, at least one of the first sidewall and the second sidewall is configured to deflect in the compressed configuration.

In some embodiments, an actuation mechanism may include a compressible frame that is compressible from a neutral configuration and into a compressed configuration. The compressible frame may include a central ring, corner members spaced apart and in the perimeter of the central ring, wherein each corner member is connected to the central ring by at least one flexure, and at least one actuation component positioned along the at least one flexure. In some embodiments, the at least one actuation component reduces spacing between the respective corner members into a first stable position when the compressible frame is compressed and the central ring is in a first orientation, and the at least one actuation component reduces spacing between the respective corner members into a second stable position when the compressible frame is compressed and the central ring is in a second orientation. Further, at least one flexure buckles in the first stable position or the second stable position of the compressed configuration of the compressible frame, and at least one of the corner members and at least one flexure may include compliant materials.

### BRIEF DESCRIPTION OF THE DRAWINGS

The embodiments described above will more fully understood from the following detailed description taken in conjunction with the accompanying drawings. The drawings are not intended to be drawn to scale. For the purposes of clarity, not every component may be labeled in every drawing. In the drawings:

FIG. 1 illustrates a diagram of a three-dimensional printed compliant mechanism in a neutral state, in accordance with some embodiments of the present disclosure;

FIG. 2A illustrates a diagram of a three-dimensional printed compliant mechanism in a compressed state at a first printed position, in accordance with some embodiments of the present disclosure;

FIG. 2B illustrates a diagram of a three-dimensional printed compliant mechanism in a compressed state at a first stable position under a first pressure, in accordance with some embodiments of the present disclosure;

FIG. 2C illustrates a diagram of a three-dimensional printed compliant mechanism in a compressed state at a first stable position under a second pressure, in accordance with some embodiments of the present disclosure;

FIG. 3A illustrates a diagram of a three-dimensional printed compliant mechanism in a compressed state at a first printed position, in accordance with some embodiments of the present disclosure;

FIG. 3B illustrates a diagram of a three-dimensional printed compliant mechanism in a compressed state at a second stable position under a first pressure, in accordance with some embodiments of the present disclosure;

FIG. 3C illustrates a diagram of a three-dimensional printed compliant mechanism in a compressed state at a second stable position under a second pressure, in accordance with some embodiments of the present disclosure;

FIG. 4 illustrates a diagram of a three-dimensional printed compliant mechanism in a compressed state between stable positions, in accordance with some embodiments of the present disclosure;

FIG. 5 illustrates a diagram of a section of a three-dimensional printed compliant mechanism, in accordance with some embodiments of the present disclosure;

FIG. 6A illustrates a diagram of a three-dimensional printed compliant mechanism in a neutral state, in accordance with some embodiments of the present disclosure;

FIG. 6B illustrates a diagram of a three-dimensional printed compliant mechanism in a first stable state, in accordance with some embodiments of the present disclosure; and

FIG. 6C illustrates a diagram of a three-dimensional printed compliant mechanism in a second stable state, in accordance with some embodiments of the present disclosure; and

FIG. 7A illustrates a diagram of a three-dimensional printed compliant mechanism in connection with an energy harvesting generator, in accordance with some embodiments of the present disclosure;

FIG. 7B illustrates a diagram of a section of a three-dimensional printed compliant mechanism in connection with the energy harvesting generator of FIG. 7A, in accordance with some embodiments of the present disclosure;

FIG. 8A illustrates a diagram of a three-dimensional printed compliant mechanism in connection with an energy harvesting generator in a first state, in accordance with some embodiments of the present disclosure;

FIG. 8B illustrates a diagram of a three-dimensional printed compliant mechanism in connection with an energy harvesting generator in a second state, in accordance with some embodiments of the present disclosure;

FIG. 8C illustrates a diagram of a three-dimensional printed compliant mechanism in connection with an energy harvesting generator in a third state, in accordance with some embodiments of the present disclosure;

FIG. 9A illustrates actuation of a three-dimensional compliant mechanism in a first stable state, in accordance with some embodiments of the present disclosure;

FIG. 9B illustrates actuation of a three-dimensional compliant mechanism in a unstable intermediate state, in accordance with some embodiments of the present disclosure;

FIG. 9C illustrates actuation of a three-dimensional compliant mechanism in a second stable state, in accordance with some embodiments of the present disclosure;

FIG. 10A illustrates actuation of a pre-loaded compliant mechanism in a pre-loaded state, in accordance with some embodiments of the present disclosure;

FIG. 10B illustrates a sectional view of actuation of a pre-loaded compliant mechanism in a pre-loaded state, in accordance with some embodiments of the present disclosure;

FIG. 11A illustrates actuation of a pre-loadable compliant mechanism after actuation in a stable rest state, in accordance with some embodiments of the present disclosure;

FIG. 11B illustrates a sectional view of actuation of a pre-loadable compliant mechanism after actuation in a stable rest state, in accordance with some embodiments of the present disclosure;

FIG. 12A illustrates actuation of a pre-loaded compliant mechanism with a hair trigger in a pre-loaded state, in accordance with some embodiments of the present disclosure;

FIG. 12B illustrates a sectional view of actuation of a pre-loaded compliant mechanism with a hair trigger in a pre-loaded state, in accordance with some embodiments of the present disclosure;

FIG. 12C illustrates actuation of a pre-loaded compliant mechanism with a hair trigger in a stable rest state, in accordance with some embodiments of the present disclosure; and

FIG. 12D illustrates a sectional view of actuation of a pre-loaded compliant mechanism with a hair trigger in a stable rest state, in accordance with some embodiments of the present disclosure.

### DETAILED DESCRIPTION

Certain exemplary embodiments will now be described to provide an overall understanding of the principles of the structure, function, manufacture, and use of the apparatus, devices, and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, device, and methods, such dimensions are not intended to limit the types of shapes that may be used in conjunction with such systems, device, and methods. A person skilled in the art will recognize that an equivalent to such linear and circular dimensions may easily be determined for any geometric shape. Sizes and shapes of the systems and devices, and the components thereof, may depend at least on the dimensions of the subject in which the systems and devices will be used, and the methods with which the systems and devices will be used.

Exemplary compliant mechanisms that can be used as a symmetric switch for actuating various devices, such as energy harvesting generators, are provided. For example, such a compliant mechanism may be additively manufactured (e.g., three-dimensionally (“3D”) printed, etc.) into a neutral position that couples one or more movable components (e.g., an actuator, a switch, etc.) of the mechanism to the mechanism's frame. In the neutral position, the compliant mechanism may be configured to minimize stresses in the flexures of the compliant mechanism. The compliant mechanism can include one or more gap elements formed in the frame that allow for the mechanism to compress when inserted into a housing such that one or more movable components are movable between first and second positions in which the mechanism is in a stable state. Accordingly, when the compliant mechanism is actuated between the first and second positions in the compressed configuration, an equal amount of stress may be imparted on the flexures such that a user of the compliant mechanism can apply equal force when moving the compliant mechanism between the first and second positions. Thus, the compliant mechanism may be used as a symmetrically-acting switch that provides consistent force feedback to the user when moving the movable component of the compliant mechanism between the first and second positions. Although symmetrically-acting bistable switches with two stable states are discussed, an actuation mechanism may include any number of stable states including one, two, three, four, five, etc.

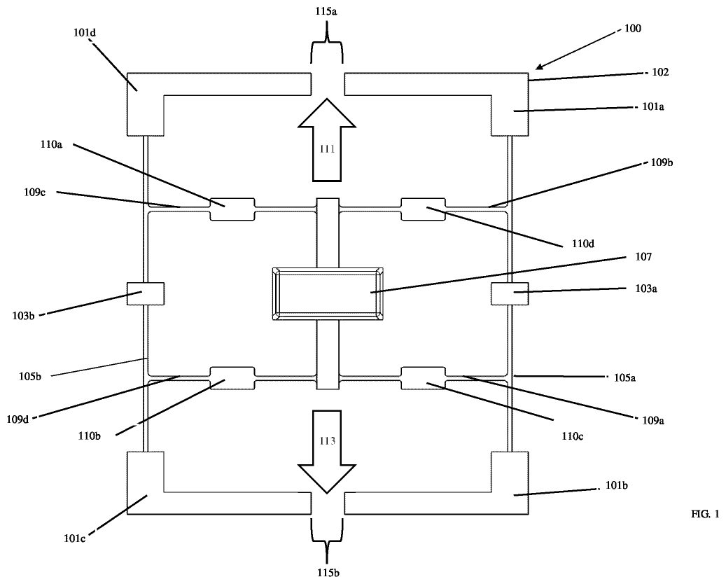

FIG. 1 illustrates one exemplary embodiment of a compliant mechanism 100 that can be used as a symmetrically bistable switch. In other embodiments, a complaint mechanism may include a plurality of stable states. In this illustrated embodiment, the compliant mechanism 100 is 3D printed, however, the compliant mechanism 100 may be manufactured using other plastic component manufacturing techniques, such as plastic extrusion processes, injection molding, and the like. In some embodiments, the compliant mechanism 100 may be printed in a neutral position or configuration that is separate from a first stable switch position and a second stable switch position. For example, in the neutral position of mechanism 100 illustrated in FIG. 1, flexures 109a, 109b, 109c, 109d are positioned neutrally, such that each of the flexures 109a, 109b, 109c, 109d, experiences equal and stresses that are symmetric. As illustrated, the neutral position may not correspond to a switch position. Accordingly, when the switch mechanism 100 is actuated from one switch position to another, the flexures 109a, 109b, 109c, 109d experience symmetrical and equal stresses in both directions of actuation. This is in contrast to conventional systems where the switch would be printed in a first switch state having no additional pressure on flexures, but then would experience additional stresses or strains when the switch was actuated from the first switch state to a second switch state. In such a system, the stresses experienced by the flexures when the switch is actuated from the first switch state to the second switch state are not the same as those experienced by the flexures when the switch is actuated from the second switch state to the first switch state, and thus the system features asymmetric force feedback in actuation.

As shown in FIG. 1, the switch mechanism 100 may include a compressible frame 102 that is substantially rectangular in shape with a first set of corner members 101a, 101b joined by a compliant sidewall members 105a, and a second set of corner members 101c, 101d joined by a second compliant sidewall members 105b. Although a rectangular shape is illustrated, the compressible frame 102 could have any suitable shape. A switch component or central actuating member 107 may be integrated and connected to a plurality of flexures forming a flexure network within the interior of the mechanism and connect switch component 107 to the flexure network bridging to the sidewall members 105a, 105b. Side members 103a, 103b may be positioned along and joined by compliant sidewall members 105a, 105b. In some embodiments, corner members 101a, 101d may be separated by a gap element 115a. In some embodiments, corner members 101b, 101c may be separated by a gap element 115b.

In some embodiments, a compressive force may be applied on sidewall members 105a, 105b. The gap elements 115a, 115b may allow for the mechanism 100 to compress when it inserted into a housing. In some embodiments, the compressive force may result in the mechanism 100 being compressed due to the positioning of gap elements 115a, 115b, which allow for corner members 101a, 101d to translate closer to each other when there is a compressive force on sidewall members 105a, 105b. Similarly, corner members 101b, 101c may translate closer to each other when there is compressive force on sidewall members 105a, 105b. Flexures 109a, 109b, 109c, 109d may be composed of flexure components or pieces that are joined by rigid anchors 110a, 110b, 110c, 110d.

In some embodiments, the mechanism 100 may be compressed and inserted into a housing. For example, the printed mechanism 100 may be configured to have a width larger than the width of the housing that the printed mechanism is configured to be inserted into. The printed mechanism 100 may be compressed by a tool and then inserted into a housing. Because the switch is printed in a neutral position, compression of the printed mechanism may cause buckling of the flexures 109a, 109b, 109c, 109d such that the switch component 107 moves in either a first direction 111 or a second, opposite direction 113, as explained in further detail below.

For example, as the mechanism 100 is compressed, the flexures 109a, 109b, 109c, 109d may buckle and translate in the first direction 111 to a first configuration in which the mechanism 100 is in a first stable state, or, alternatively, the flexures 109a, 109b, 109c, 109d may buckle and translate in the second direction 113 to a second configuration in which the mechanism 100 is in a second stable state. As the buckling and translation from the neutral position to the first configuration is the same as the buckling and translation from the neutral position to the second configuration when the mechanism 100 is compressed, the flexures 109a, 109b, 109c, 109d experience the same levels of stress and strain regardless of whether the device is moved to the first configuration or to the second configuration from the neutral position.

As the printed mechanism 100 is compressed, the strain imparted on the thin walls 110 may be controlled in accordance with the spacing between the sidewalls 105a, 105b. For example, the amount of compression applied to the printed mechanism 100 may change the stroke length of an actuation element connected to the mechanism 100.

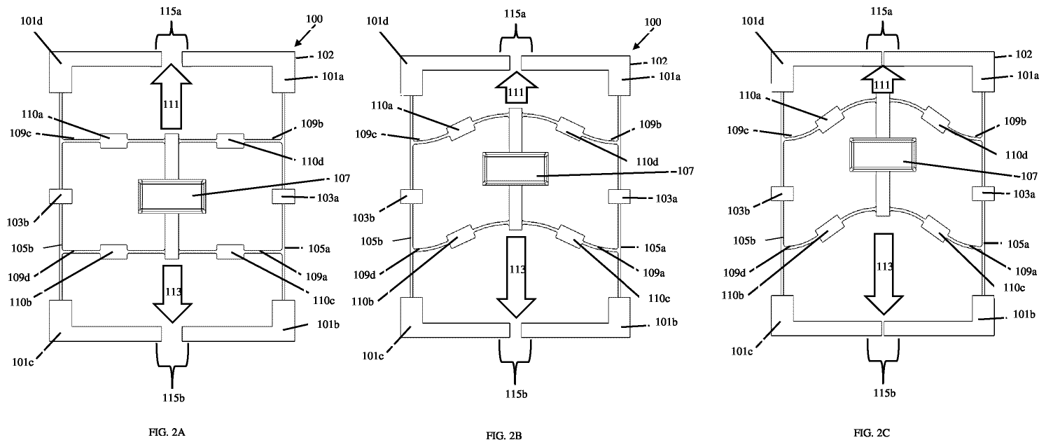

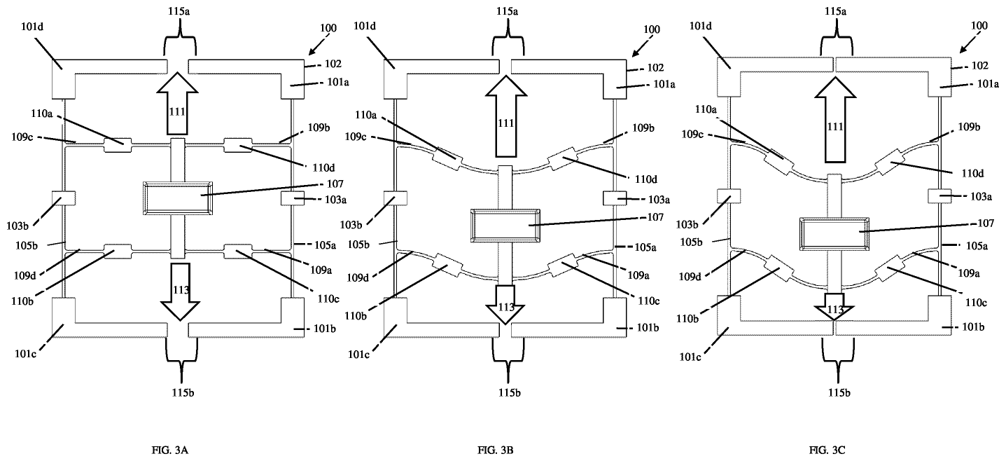

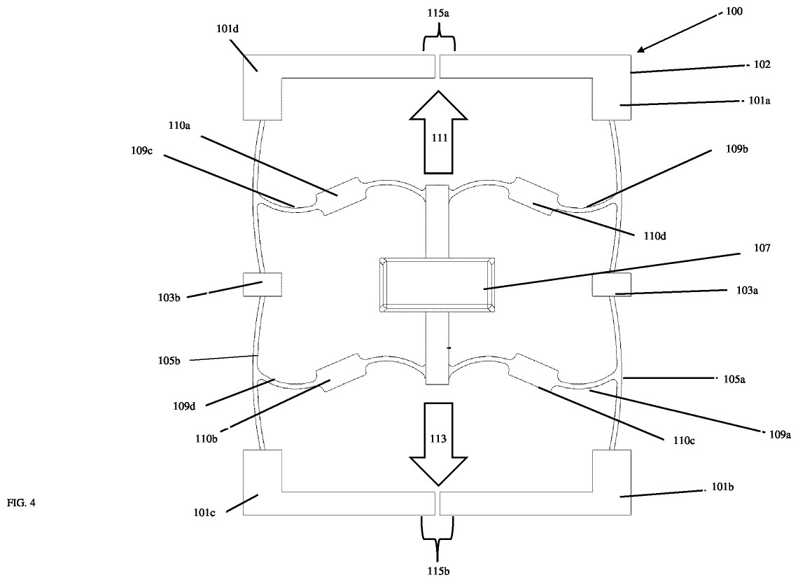

In some embodiments, an actuation element may be a switch component 107. As the switch component 107 is coupled to the flexures 109a, 109b, 109c, 109d, the buckling and translation of the flexures 109a, 109b, 109c, 109d to either of the first configuration and the second configuration causes corresponding movement of the switch component 107. For example, in some embodiments, as switch component 107 moves from the neutral position illustrated in FIG. 1 to a first stable state (see FIG. 2), the switch component 107 moves substantially in the first direction 111 such that flexures 109a, 109b, 109c, 109d, experience stress and strain as a first end of each flexure remains fixed upon a respective sidewall members 105a, 105b, and the other end of each flexure translates with the switch component 107 in the first direction 111. Similarly, in some embodiments, as switch component 107 moves from the neutral position illustrated in FIG. 1 to a second stable state (see FIG. 3), the switch component 107 moves substantially in the second direction 113 such that flexures 109a, 109b, 109c, 109d, experience stress and strain as a first end of each flexure remains fixed upon a respective sidewall members 105a, 105b, and the other end of each flexure translates with the switch component 107 in the second direction 113.

In some embodiments, the sidewall members 105a, 105b are also composed of compliant materials similar to the flexures such that they also experience stress and strain as compression is applied to the frame 100. Accordingly, the sidewall members 105a, 105b may also undergo buckling. In other words, the vertical sections of the frame including sidewall members 105a, 105b may also be deflected as they experience strain in the compressed state.

When in the compressed state, the switch component 107 can be translated between the first position and the second position. For example, as will be illustrated in the progression from FIG. 2A to 2B, the switch component may translate from a neutral as-printed position to a first position in a first direction. Similarly, as is illustrated in the progression from FIG. 3A to 3B, the switch component may translate from the neutral as-printed position to a second position in a second direction. When the switch component is translated from the first position to the second position, the flexures 109a, 109b, 109c, 109d may experience stresses and strains when translating from the first position to an intermediate position between the first position and the second position that are the same as those experienced when translating from the intermediate position to the second position. Similarly, when the switch component is translated from the second position to the first position, the flexures 109a, 109b, 109c, 109d may experience stresses and strains when translating from the second position to the intermediate position that are the same as those experienced when translating from the intermediate position to the first position. As such, the flexures 109a, 109b, 109c, 109d are configured to symmetrically buckle about the intermediate position, and so a user may experience the same amount and type of force feedback from the mechanism 100 when translating the switch component 107 between the first position and the second position. Accordingly, the disclosed mechanism 100 may provide for symmetrical actuation in a bistable device, thereby providing both enhanced user qualitative experience and functional performance of the device in which the mechanism is integrated. By contrast, some conventional systems are configured to be printed in a first state that experiences no strains, and the asymmetrically actuate to a second state with limited strains. Accordingly, in some conventional systems the stress and strain and buckling felt by components is not equal or symmetric as the device moves from one state to another.

In some embodiments, in some embodiments, the mechanism 100 may have a reduced width equivalent to 50-70% of the width of the mechanism as printed, when in a compressed state.

As shown in FIGS. 2A-2C, a switch component 107 may have a first stable state where the actuation is moved in direction 111. In FIG. 2A, a printed compliant mechanism 100 analogous to that shown in FIG. 1 is illustrated. FIG. 2A may correspond to the printed compliant mechanism 100 after it has been manufactured and prior to it being compressed, engaged with, and/or fit into other components.

Taken together, FIGS. 2A and 2B illustrate movement of the switch from the neutral, as-printed position to a first stable state responsive to the application of a first amount of compressive force on the compliant mechanism. Similarly, FIGS. 2A and 2C illustrate the movement of the switch from the neutral, as-printed position to the first stable state responsive to the application of a greater amount of compressive force on the compliant mechanism.

As shown in FIG. 2B, the corner members 101a and 101d move substantially towards each other and reduce the gap 115a. Similarly, corner members 101c and 101b move substantially towards each other and reduce the gap 115b. As the actuation component 107 is moved in direction 111, the flexures 109a, 109b, 109c, and 109d experience buckling, or stress. Additionally sidewall members, 105a, 105b also experience bowing and deflection, and in some embodiments absorb the strain.

As shown in FIG. 2C, a stable state of the mechanism 100 is illustrated, where additional compressive force is placed on the corner members 101a, 101b, 101c, and 101d, when compared to the corner members in FIG. 2B. Accordingly, the corner members 101a and 101d move even closer together (when compared to those in FIG. 2B), further reducing the gap 115a. Similarly, the corner members 101c and 101b also move closer to each other, reducing gap 115b.

As show in FIGS. 3A-3C, an actuation component 107 may have a second stable state where the actuation component is moved in direction 113. In FIG. 3A, a printed compliant mechanism 100 analogous to that shown in FIG. 1 is illustrated.

As illustrated in FIGS. 3B and 3C the second stable state may be in direction 113 which is opposite to the first stable state illustrated in FIGS. 2B and 2C in direction 111.

Taken together, FIGS. 3A and 3B illustrate movement of the switch from the neutral, as-printed position to a second stable state responsive to the application of a first amount of compressive force on the compliant mechanism. Similarly, FIGS. 3A and 3C illustrate the movement of the switch from the neutral, as-printed position to the second stable state responsive to the application of a greater amount of compressive force on the compliant mechanism than was illustrated in FIG. 3B.

In FIG. 3B the corner members 101a, 101b, 101c, 101d are compressed. The corner members 101a and 101d move substantially towards each other and reduce the gap 115a. Similarly, corner members 101c and 101b move substantially towards each other and reduce the gap 115b. As the actuation component 107 is moved in direction 111, the flexures 109a, 109b, 109c, and 109d experience buckling, or stress. Additionally sidewall members, 105a, 105b also experience bowing and deflection, and take on the strain.

In FIG. 3C, a second stable state of the mechanism 100 is illustrated, where the corner members are compressed by a greater amount of compressive force than is illustrated in FIG. 3B. In the third panel, the corner members 101a and 101d move even closer together, further reducing the gap 115a. Similarly, the corner members 101c and 101b also move closer to each other, reducing gap 115b.

As demonstrated in FIGS. 2A and 3A, the compliant mechanism 100 can be printed in a neutral state that does not place strain on flexures. However, in contrast to conventional systems, the actuator has two stable states (illustrated by FIGS. 2B and 3B) in which additional equal stresses are placed on flexures. Further, if additional forces are applied on the compliant mechanism, components of the compliant mechanism 100 may translate closer to together as is illustrated in FIGS. 2C and 3C. Accordingly, a user may experience the same feel moving from the neutral state to the first position illustrated in the third panel of FIG. 2 and the third panel of FIG. 3, despite the states having different positioning for the actuator element.

FIG. 4 illustrates the compliant mechanism 100 between the stable states illustrated in FIGS. 2B, 2C, 3B, and 3C. As illustrated, the flexures 109a, 109b, 109c, 109d may be flexible and bend as a compressive force is applied to corner members 101a, 101b, 101c, 101d. Further, sidewall members 105a, 106b also experience stress and strain and undergo buckling as compression is applied to the frame 100.

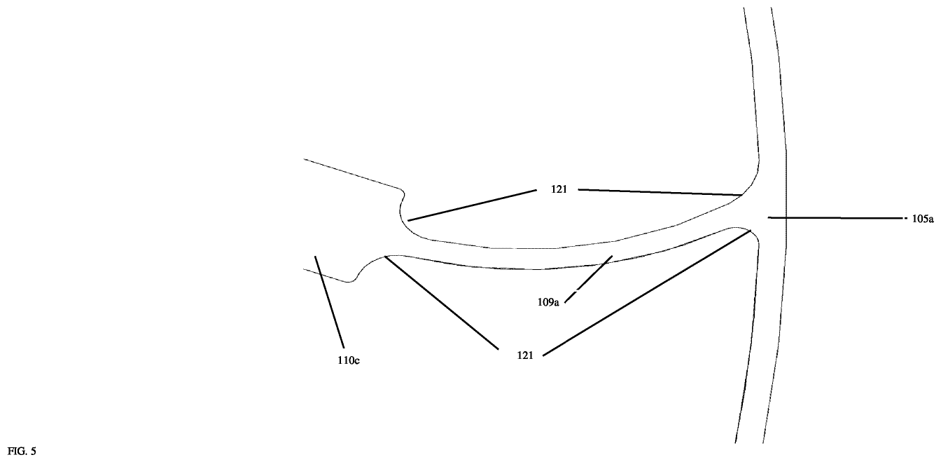

FIG. 5 provides a section view of a three-dimensional printed compliant mechanism 100. As illustrated in FIG. 5, flexure 109a may be shaped to have rounded corners 121. The rounded corners 121 of the flexures may be configured to form junctions with the rigid members 110c of the compressible frame. The rounded corners may be configured to reduce the stress placed at the intersection of the flexures 109a and rigid members 110c and further dissipate stress, and prevent failure of the system. In some embodiments, the flexures may have rounded hinged parts. Corresponding rigid members may include one or more holes positioned to accept the flexures. For example, the flexures may slide into receiving slots or holes positioned along the rigid members. This may reduce breakage and failure points at the intersection of the flexures and rigid members. Flexures (e.g., 109a, 109b, 109c, 109d of FIG. 1, and 207 of FIGS. 2A-2C) may be composed of flexure components or pieces that are joined by rigid anchors.

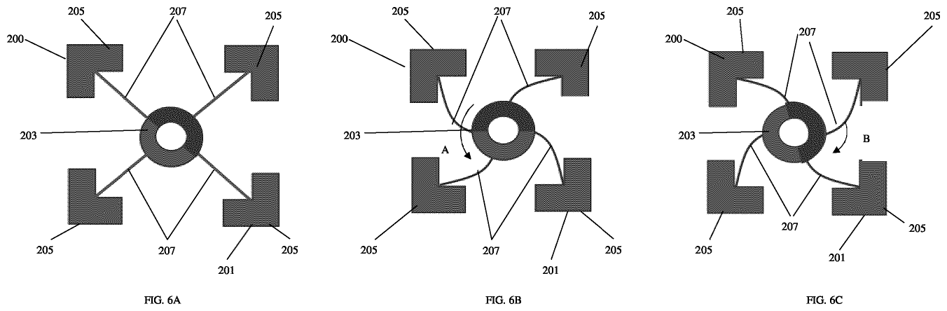

FIGS. 6A-6C illustrate a second exemplary embodiment of a compliant mechanism 200 that can be used as rotary bi-stable mechanisms. In this embodiment, the compliant mechanism 200 is 3D printed, however, the compliant mechanism 200 may be manufactured using other plastic component manufacturing techniques, such as plastic extrusion processes, injection molding, and the like. In some embodiments, the compliant mechanism 200 may be printed in a neutral position or configuration (see FIG. 6A) that is separate from a first stable position (see FIG. 6B) and a second stable position (see FIG. 6C).

The compliant mechanism 200 may include a compressible frame 201. The compressible frame 201 may be compressible from a neutral configuration as illustrated in FIG. 6A into a compressed configuration, such as that illustrated in FIGS. 6B and 6C. The compressible frame 201 may include a central ring 203. The compressible frame may include corner members 205 that are spaced apart and in the perimeter of the central ring 203. In some embodiments, each corner member 205 may be connected to the central ring 203 by at least one flexure 207. In some embodiments, when a force is applied to corner members 205, the spacing between the corner members 205 is reduced such that the frame 201 is compressed, and the flexures 207 may buckle. Additionally, the central ring 203 may rotate from a neutral orientation to a first or second orientation when compressed due in part to the movement of the buckling flexures. Alternatively the rotation of the central ring 203 may be mediated by an actuation component.

As the central ring 203 is rotated in direction A, the spacing between the rigid members 205 may be decreased and flexures 207 may buckle until the compliant mechanism 200 reaches a first stable state illustrated in FIG. 6B. As the central ring continues to be rotated in a second direction B, the spacing between the rigid members 205 is also decreased and flexures 207 buckle until the compliant mechanism 200 reaches a second stable state illustrated in FIG. 6C. Notably, the flexures may buckle in opposite directions, in accordance with the direction that the central ring 203 is rotated. A user may experience a “snap action” as the central ring 203 is rotated until the flexures 207 and central ring 203 move into the stable state illustrated in FIG. 6B or 6C.

In some embodiments, the gaps between rigid members 205 may be filled by gap fillers (not shown) that are configured to constrain the amount that compressible frame 201 is able to be compressed within a housing. The gap fillers (not shown) may prevent the compressible frame from moving within a housing.

The disclosed compliant mechanisms (e.g., 100 and 200) may provide for “snap action” which may allow for symmetrical actuation between various stable states of a mechanism. The “snap action” may isolate the impact of variations in user acceleration, force, or movement. For example, the slower input of a user actuation may be isolated such that the energy harvesting generator can operate with stable input, which may allow for improved energy harvesting. Further the “snap action” may reduce or eliminate friction felt by the user.

In some embodiments, a mechanism such as the described mechanism 100 may be attached to one or more magnetic components configured about a wire coil such that the mechanism may be used in electromagnetic technology for generating energy. For example, mechanical action of a switch including the mechanism described herein may be used to output energy. In some embodiments, the described mechanism may be integrated into battery-less solutions for lighting, security, sensors, and the like.

For example, in some embodiments, the described mechanism 100 may be integrated into an energy harvesting generator, such that the described mechanism 100 is a switch that actuates the movement of one or more magnets of the energy harvesting generator. In some embodiments, the mechanism 100 may actuate the movement of a magnet positioned within a coil formed from a plurality of turns of wire, and the movement of the magnet within the coil may induce a voltage between the terminal ends of the wire forming the coil. For example, when described mechanism 100, incorporated into such an energy harvesting generator, is moved from the first position to the second position as described above, and vice versa, the mechanism 100 may cause the magnet to rotate within the coil and thereby induce a voltage between the terminal ends of the wire forming the coil.

In some embodiments, when the described mechanism 100 is integrated into an energy harvesting generator, the described mechanism 100 may provide for snap-action and consistent actuation of components within an energy harvesting generator. To that end, the described mechanism 100 may isolate or minimize user-induced variation in actuation. Further, the described mechanism 100 may provide a frictionless feel to a user, such that the user experiences minimal or no drag.

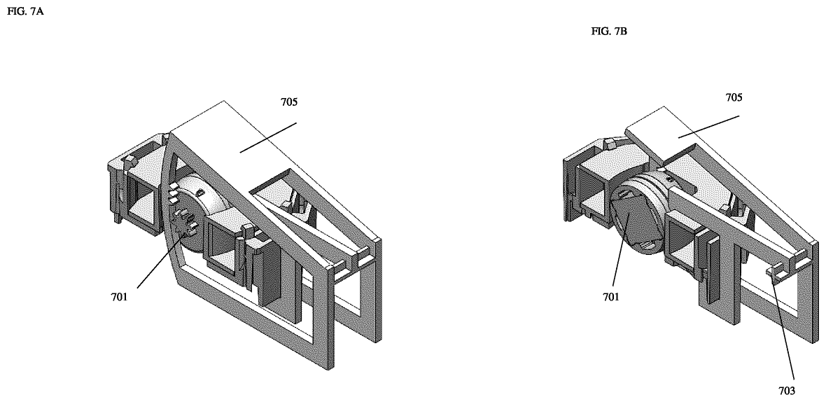

FIGS. 7A and 7B provide an example of a three-dimensional printed compliant mechanism 703 that is used in connection with an energy harvesting generator 701. As illustrated in FIGS. 7A and 7B, the three-dimensional printed compliant mechanism 703 may form a torsional flexure that is integrated into an actuation member 705. As the actuation member is pressed down, the actuation member may engage with a component of the energy harvesting generator 701 such as the central magnet. The three-dimensional printed compliant mechanism 703 may form a torsional flexure analogous to the described mechanism 200. In some embodiments, the actuation member 705 may be composed of a single-molded piece. In some embodiments, the torsional flexure 703 may act like a spring and have a wind-up and return capability. In some embodiments, the torsional flexure may provide for bi-directional actuation the actuation member is depressed and released.

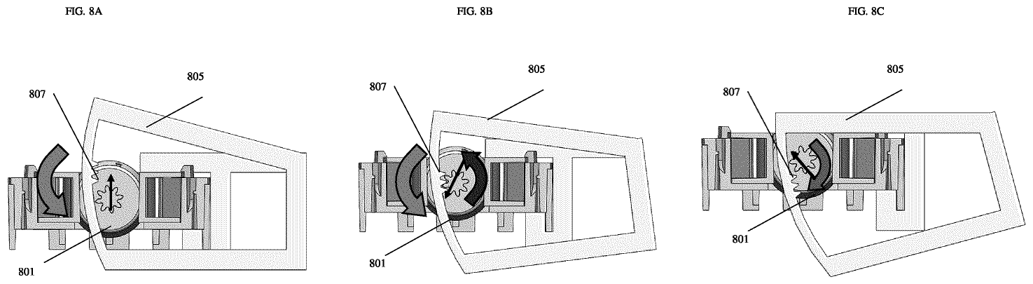

FIG. 8A-8C provide an example of the three-dimensional printed compliant mechanism in connection with an energy harvesting generator analogous to the one illustrated in FIGS. 7A and 7B, as it actuates from an at-rest position (FIG. 8A), depressed position (FIG. 8B), and a released position (FIG. 8C). As illustrated in FIG. 8A, in the at-rest position, the central magnet of the energy harvesting generator 801 is engaged with the actuation member 805, for example, via a teethed connector element 807. As illustrated in FIG. 8B, as the actuation member 805 is depressed, the teethed connector element 807 leads to the winding up of a rotor in the energy harvesting generator 801. Finally, as illustrated in FIG. 8C, at the end of the actuation stroke the rotor is released and the energy harvesting generator 801 has generated energy.

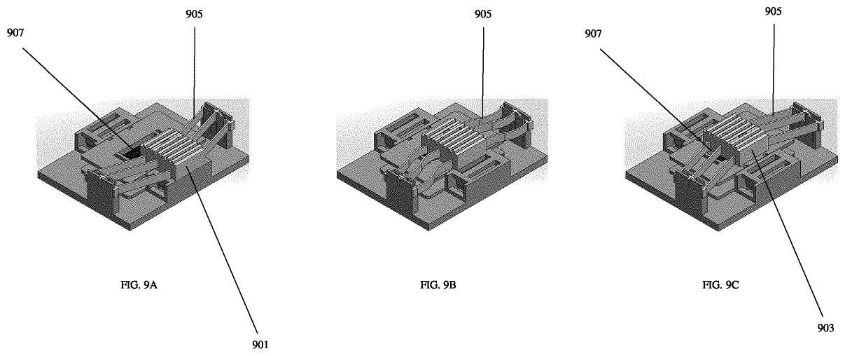

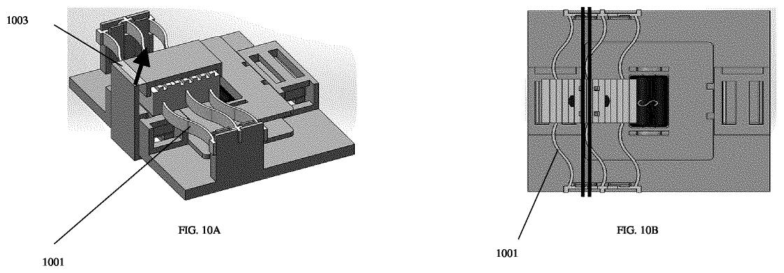

FIGS. 9A-9C provide an illustration of actuation of a three-dimensional compliant mechanism from a first stable state (FIG. 9A), through an intermediate state (FIG. 9B) to a second stable state (FIG. 9C). As shown in FIGS. 9A-9C, the compliant mechanism 900 may have two stable states positioned opposite each other such that the actuation from one stable state 901 to a second stable state 903 may act as a switch. As the compliant mechanism is actuated from one stable state 901 to a second stable state 903, the flexures 905 may undergo stresses and/or buckling. FIGS. 9A-9C provide an illustration of a symmetrical bistable compliant mechanism. In some embodiments, magnetic attractive force between an actuator magnet and a rotor of an energy harvesting generator may cause friction of the actuator button, however the illustrated compliant mechanism may suspend the actuator slide button from contacting the rotor and thus eliminates stiction and/or friction for better feel and more reliable actuation. In some embodiments, the illustrated three-dimensional compliant mechanism may provide for “snap-action” in that the compliant mechanism may actuate rapidly between a first and second stable state. In some embodiments, the three-dimensional compliant mechanism illustrated in FIGS. 9A-9C may be coupled to an energy harvesting generator. As illustrated in FIG. 9A, when a window 907 opens due to actuation to a stable state, the prepositioned rotor of an energy harvesting generator wants to restore to neutral position that is aligned to focus magnets and generates energy pulse. As shown in FIG. 9C, in an embodiment where a window 907 may include a magnet or ferrous plate, when the rotor “flips” up, it may generate pulse energy, and the energy harvesting generator may be preloaded for energy release when window opens.

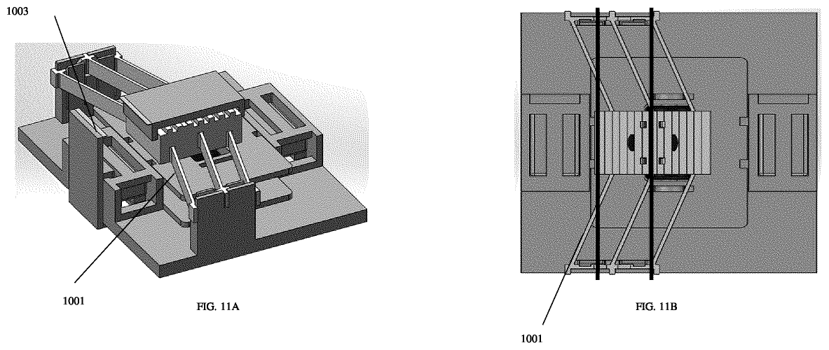

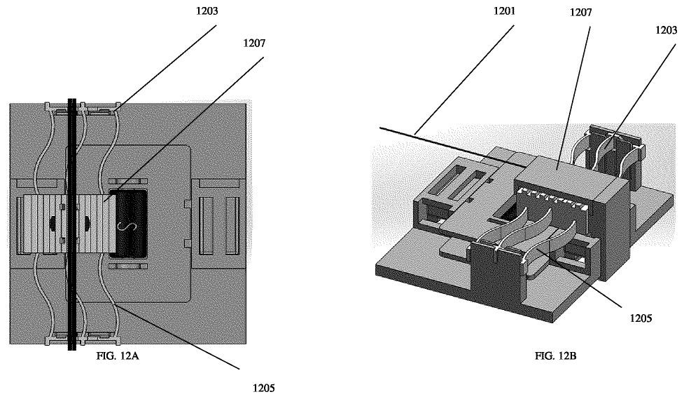

FIGS. 10A-11B illustrate actuation of a pre-loaded compliant mechanism. As illustrated in FIG. 10A, a compliant mechanism may be pre-loaded with force and include a retention mechanism. For example a retention mechanism or film strip 1003 may be used to pre-load the compliant mechanism, such that the flexures 1001 are buckled. FIG. 10B provides a sectional view of the compliant mechanism structure of FIG. 10A.

As illustrated in FIGS. 11A-11B, when the retention mechanism or film strip 1003 is removed, the switch may actuate to a second stable position, where the flexures 1101 no longer experience buckling. FIG. 11B provides a sectional view of the compliant mechanism structure of FIG. 11A. Potential energy stored by the flexures 1101 may be released to provide an energy pulse output as the switch is actuated.

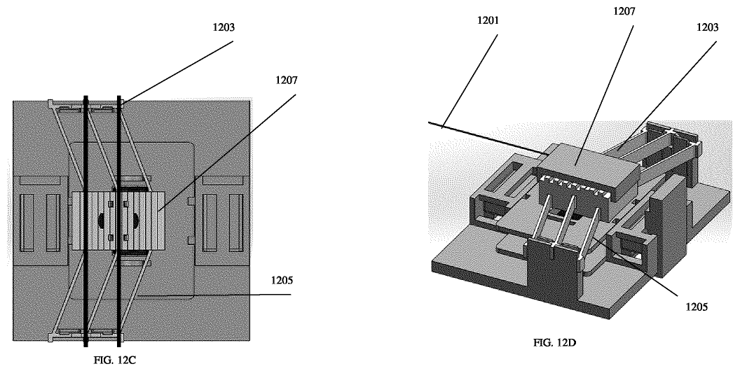

FIGS. 12A-12D illustrates an embodiment, where the compliant mechanism may be coupled to an energy harvesting generator with a stable pre-loaded state and hair trigger 1201. For example, as illustrated in FIGS. 12A and 12B in some embodiments, the compliant mechanism 1203 may not require a retention mechanism or film strip to retain the switch 1207 in one place. Instead, the compliant mechanism 1203 may be designed to be pre-loaded at a point such that it creates a stable position. The compliant mechanism may be designed to require very minimal force for actuation. In some embodiments, the compliant mechanism 1203 may be coupled to a hair-trigger 1201 that is used for actuation. As illustrated in FIGS. 12A-12B, the compliant mechanism may be pre-loaded such that the flexures 1205 are slightly buckled. However, they do not require the presence of a retention mechanism. FIGS. 12C-12D provides an illustration of the pre-loaded compliant mechanism of FIGS. 12A-12B when the switch 1207 has moved to a second position and so the flexures 1205 are in a rest position.

One skilled in the art will appreciate further features and advantages of the invention based on the above-described embodiments. Accordingly, the invention is not be limited by what has been particularly shown and described, except as indicated by the appended claims.

We claim:

1. An actuation mechanism comprising:
a compressible frame that is compressible from a neutral configuration and into a compressed configuration, the compressible frame comprising:
a first sidewall with ends having corner members;
a second sidewall with ends having corner members, the second sidewall spaced apart from the first sidewall, and the second sidewall connected to the first sidewall by at least one flexure; and
at least one actuation component positioned along the at least one flexure;
wherein the corner members of the first sidewall are spaced apart from the corner members of the second sidewall in the neutral configuration of the compressible frame, and
wherein the corner members of the first sidewall are adjacent to the corner members of the second sidewall in the compressed configuration of the compressible frame, wherein the at least one flexure buckles in the compressed configuration of the compressible frame,
wherein at least one of the two sidewalls, corner members, and at least one flexure comprises compliant materials.

2. The actuation mechanism of claim 1, wherein the compressible frame comprises a first stable state within the compressed configuration in which the at least one actuation component is in a first position.

3. The actuation mechanism of claim 2, wherein the compressible frame comprises a second stable state within the compressed configuration in which the at least one actuation component is in a second position.

4. The actuation mechanism of claim 3, wherein actuation from the first stable state to the second stable state requires equivalent force as actuation from the second stable state to the first stable state.

5. The actuation mechanism of claim 4, wherein movement of the at least one actuation component actuates the assembly from the first stable state to the second stable state or from the second stable state to the first stable state.

6. The actuation mechanism of claim 1, wherein the actuation component is a switch.

7. The actuation mechanism of claim 1, wherein ends of the at least one flexure comprise rounded edges configured to engage with a receiving element on at least one of the two sidewalls, and corner members.

8. The actuation mechanism of claim 1, wherein at least one of the first sidewall and the second sidewall is configured to deflect in the compressed configuration.

9. A method comprising:
manufacturing a compressible frame, the compressible frame further comprising:
a first sidewall with ends having corner members,
a second sidewall with ends having corner members, the second sidewall spaced apart from the first sidewall, and the second sidewall connected to the first sidewall by at least one flexure, and
at least one actuation component positioned along the at least one flexure, wherein at least one of the two sidewalls, corner members, and at least one flexure comprises compliant materials;
compressing the compressible frame by applying force to the first sidewall and the second sidewall of the compressible frame;
inserting the compressed frame into a housing for electromagnetic applications; and
actuating the actuation component from a first stable state position to a second stable state position.

10. The method of claim 7, wherein the manufacturing includes at least one of three-dimensional (3D) printing, plastic extrusion processes, and injection molding the compressible frame.

11. The method of claim 7, wherein the actuation component is a switch.

12. An actuation mechanism comprising:
a compressible frame that is compressible from a neutral configuration and into a compressed configuration, the compressible frame comprising:
a central ring;
corner members spaced apart and in the perimeter of the central ring, wherein each corner member is connected to the central ring by at least one flexure; and
at least one actuation component positioned along the at least one flexure;
wherein the at least one actuation component reduces spacing between the respective corner members into a first stable position when the compressible frame is compressed and the central ring is in a first orientation,
wherein the at least one actuation component reduces spacing between the respective corner members into a second stable position when the compressible frame is compressed and the central ring is in a second orientation,
wherein the at least one flexure buckles in the first stable position or the second stable position of the compressed configuration of the compressible frame, and
wherein at least one of the corner members and at least one flexure comprises compliant materials.
